(19) United States
(12) Patent Application Publication
(10) Pub. No.: US 2021/0342209 A1
(43) Pub. Date: Nov. 4, 2021

(54) SELF-LEARNING, CONTEXT-SENSITIVE TROUBLESHOOTING

(71) Applicant: Dell Products L.P., Round Rock, TX (US)

(72) Inventors: Saurabh KISHORE, Round Rock, TX (US); Sudhir Vittal SHETTY, Cedar Park, TX (US); Manoj Kumar MALHOTRA, Austin, TX (US); Robert A. CONTRERAS, Leander, TX (US)

(73) Assignee: Dell Products L.P., Round Rock, TX (US)

(21) Appl. No.: 16/863,665

(22) Filed: Apr. 30, 2020

(51) Int. Cl. G06F 11/07; G06F 40/30; G06F 40/284

(52) U.S. Cl. CPC G06F 11/079; G06F 11/0769; G06F 40/284; G06F 40/30

(57) ABSTRACT

An information handling system may be configured to receive, from a client information handling system, information indicative of an error; perform natural language processing of a text associated with the error to determine a set of error tokens; perform natural language processing of a plurality of items of troubleshooting content to determine, for each item of troubleshooting content, a respective set of troubleshooting tokens; for each respective set of troubleshooting tokens, determine a similarity score for the corresponding item of troubleshooting content relative to the set of error tokens; receive user feedback for a selected one of the items of troubleshooting content; and adjust the similarity score for the selected one based on the received user feedback.

### TECHNICAL FIELD

The present disclosure relates in general to information handling systems, and more particularly to intelligent troubleshooting.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Some manufacturers of information handling systems provide help content for various products in the form of troubleshooting videos, user guides, white papers, help articles, etc. But typically customers must manually perform searches and/or peruse the information to select the items that are relevant to whatever issue they may be having.

In particular, the help content is typically not associated with respective errors. Rather, the content is associated with a system model, service tag, or the like. In the case where a customer is researching an issue that is reported in the system logs, current solutions may provide a generic URL for a specific system model or service tag, and the user then must manually filter through a copious amount of information to hopefully find information relevant to the issue. This provides for a tedious, repetitive and negative customer experience. When a user does find useful documentation to remediate an issue, current troubleshooting solutions do not provide the ability to utilize user input to refine results for future users.

Accordingly, it would be advantageous to provide an intelligent, data-driven troubleshooting system. Some embodiments of this disclosure may employ artificial intelligence (AI) techniques such as machine learning, natural language processing (NLP), etc. Generally speaking, machine learning encompasses a branch of data science that emphasizes methods for enabling information handling systems to construct analytic models that use algorithms that learn interactively from data. It is noted that, although disclosed subject matter may be illustrated and/or described in the context of a particular AI paradigm, such a system, method, architecture, or application is not limited to those particular techniques and may encompass one or more other AI solutions.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with troubleshooting may be reduced or eliminated.

In accordance with embodiments of the present disclosure, an information handling system may be configured to receive, from a client information handling system, information indicative of an error; perform natural language processing of a text associated with the error to determine a set of error tokens; perform natural language processing of a plurality of items of troubleshooting content to determine, for each item of troubleshooting content, a respective set of troubleshooting tokens; for each respective set of troubleshooting tokens, determine a similarity score for the corresponding item of troubleshooting content relative to the set of error tokens; receive user feedback for a selected one of the items of troubleshooting content; and adjust the similarity score for the selected one based on the received user feedback.

In accordance with these and other embodiments of the present disclosure, a method may include an information handling system receiving, from a client information handling system, information indicative of an error; the information handling system performing natural language processing of a text associated with the error to determine a set of error tokens; the information handling system performing natural language processing of a plurality of items of troubleshooting content to determine, for each item of troubleshooting content, a respective set of troubleshooting tokens; for each respective set of troubleshooting tokens, the information handling system determining a similarity score for the corresponding item of troubleshooting content relative to the set of error tokens; the information handling system receiving user feedback for a selected one of the items of troubleshooting content; and the information handling system adjusting the similarity score for the selected one based on the received user feedback.

In accordance with these and other embodiments of the present disclosure, an article of manufacture may include a non-transitory, computer-readable medium having computer-executable code thereon that is executable by at least one processor of at least one information handling system for: receiving, from a client information handling system, information indicative of an error; performing natural language processing of a text associated with the error to determine a set of error tokens; performing natural language processing of a plurality of items of troubleshooting content to determine, for each item of troubleshooting content, a respective set of troubleshooting tokens; for each respective set of troubleshooting tokens, determining a similarity score for the corresponding item of troubleshooting content relative to the set of error tokens; receiving user feedback for a selected one of the items of troubleshooting content; and adjusting the similarity score for the selected one based on the received user feedback.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIGS. 2A and 2B (collectively referred to herein as FIG. 2) illustrate an example method, in accordance with embodiments of the present disclosure.

### DETAILED DESCRIPTION

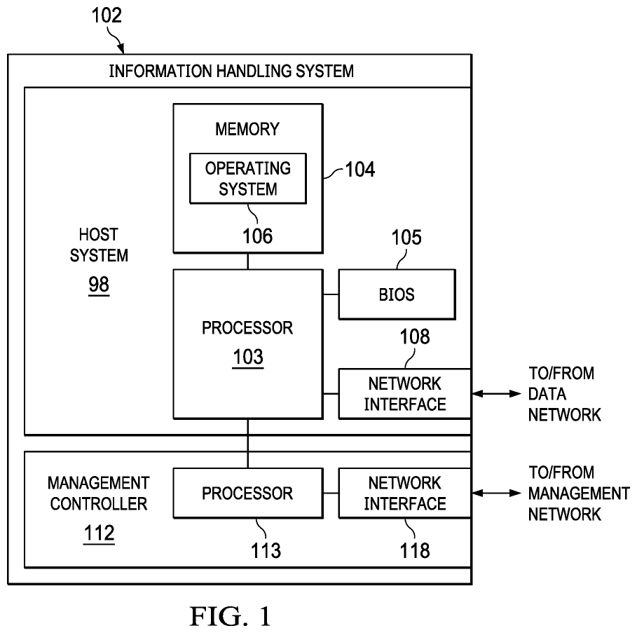

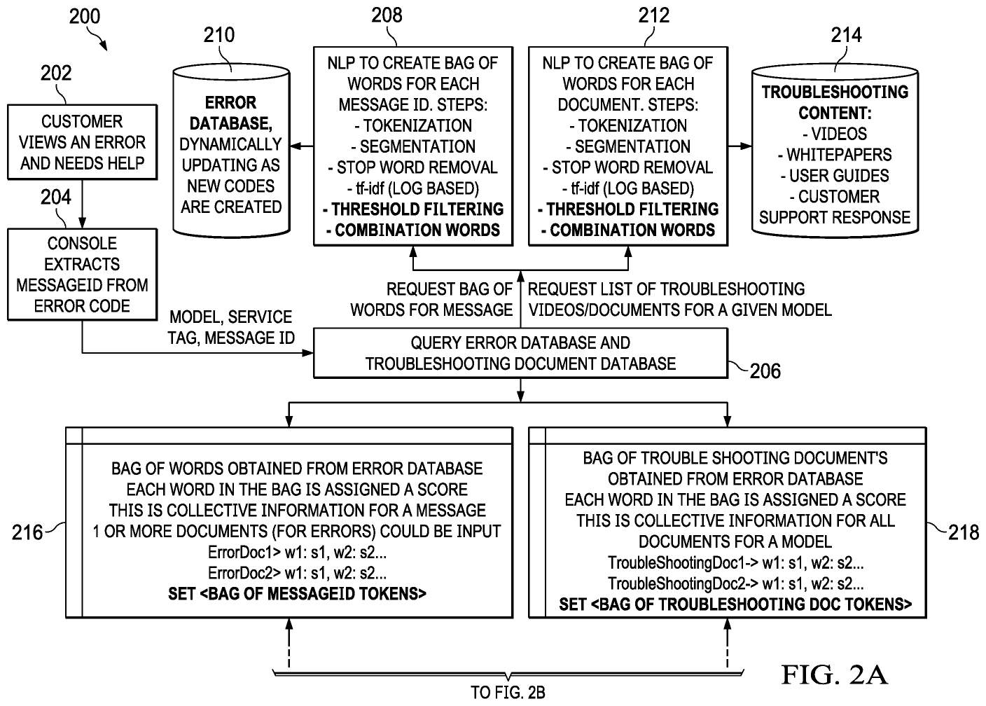

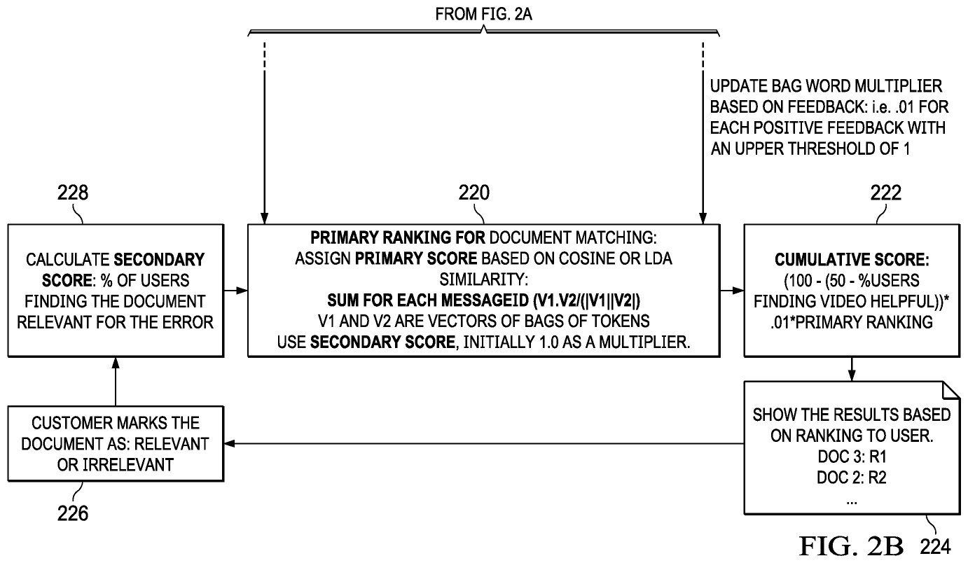

Preferred embodiments and their advantages are best understood by reference to FIGS. 1 through 2, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, various types of errors and/or other messages may be encountered by a user of an information handling system such as information handling system 102. It would be advantageous to allow users access to helpful troubleshooting content which is ranked and filtered based on the errors that have been encountered. It would further be advantageous to create a mapping of errors (e.g., an error MessageID) as keys to the ranked troubleshooting content as values. It would further be advantageous to create a self-learning mechanism based on users' feedback to improve the ranking and results.

For example, a user may be reviewing one or more fault logs and need to resolve some issue. To be successful, the user should be provided with appropriate content with remediation steps. Embodiments of this disclosure implement a mechanism to provide content for the appropriate device that has been filtered and ranked based on fault logs. This ensures that the user only sees content that is appropriate to resolve the issue at hand. Further, a self-learning mechanism may improve the filtering and ranking as more users interact with the troubleshooting system.

Turning now to FIG. 2 (which includes FIG. 2A and FIG. 2B), a flow chart is shown of an example method 200 within an example architecture, according to some embodiments.

At step 202, a user may encounter an error and receive a corresponding error message. At step 204, a console of the user's information handling system (e.g., a management console such as described above with respect to management controller 112) may extract an error code and/or a MessageID from the error.

At step 206, the user's information handling system may then query a troubleshooting system, which may include an error database and a troubleshooting document database, which may be provided by a manufacturer of the information handling system. In some embodiments, the query may include the MessageID of the error, as well as system information (e.g., model number, service tag, etc.).

An error database 210 may in some embodiments include a data set for every product made by the manufacturer. Error database 210 may include, for each error MessageID, a description of the problem, recommended remediation actions, etc. An example of an entry from such an error database is provided as follows:

{

“DetailedDescription”: “A physical disk has been removed from the disk group. This alert can also be caused by loose or defective cables or by problems with the enclosure.”,

“MessageId”: “PDR5”,

“RecommendedAction”: “Do one of the following: 1) If a physical disk was removed from the disk group, either replace the disk or restore the original disk. Identify the disk that was removed by locating the disk that has a red\“X\” for its status. 2) Perform a rescan after replacing or restoring the disk. 3) If a disk was not removed from the disk group, then check for cable problems. Refer to product documentation for more information on checking the cables. 4) Make sure that the enclosure is powered on. 5) If the problem persists, check the enclosure documentation for further diagnostic information.”

}

A goal of embodiments of the disclosed troubleshooting system is to find the best match between the error message and one or more items of troubleshooting content. This may be accomplished, in some embodiments, by generating an error vector based on the set of scored error tokens. The error vector may be made up of the scores for each token, as discussed below with respect to scored error tokens 216. (The term “token” may be understood as referring to a single word, a stripped single word, a multi-word group, a stripped multi-word group, etc.)

Similar processing may be employed to generate troubleshooting vectors for each item of troubleshooting content, as discussed below with respect to scored troubleshooting tokens 218. Determining a good match between the error message and an item of troubleshooting content may then be accomplished by comparing the similarity of their respective vectors. For example, if the error vector has high relevance scores for a token such as “RAID disk error,” then it would be advantageous to match that error to troubleshooting content that also has high relevance scores for that same token.

Accordingly, the troubleshooting system may, at step 208, perform natural language processing (NLP) for each entry of error database 210 to create a bag/set of words/tokens associated with each error. For example, text associated with each error may undergo tokenization, segmentation, stop word removal, term frequency-inverse document frequency (TF-IDF), threshold filtering, analysis of combination words, etc. The result may be a set of tokens for a MessageID (e.g., tokens being words or small groups of words), each having a relevance score relative to that MessageID.

As one example, such NLP may proceed as follows:

a. Preprocessing, sentence segmentation and tokenization (removal of extra spaces and extracting words).

b. Combination words: combining words such as “power supply”, “fan RPM”, “temperature threshold”, etc. into tokens that are relevant to the troubleshooting domain. The list of these kinds of keywords may create additional entries. This step is particularly advantageous for the troubleshooting domain, as extra weight may be applied for multi-word components.

c. Removing stop words and stripping and stemming, such as removing articles and parts of speech. (E.g., “failure” becomes “fail”, “locating” becomes “location”, “checking” becomes “check”, etc.)

d. For each word (or combination of words), calculate TF-IDF. The logarithmically scaled version of TF-IDF may be advantageous in practice.
i. TF(t)=(Number of times term t appears in a document)/(Total number of terms in the document).
ii. IDF(t)=ln(Total number of documents/Number of documents with term t in it).

e. Include the word from step d if the TF-IDF value is greater than a certain threshold.

f. The set of tokens may be cached or stored and only updated when the error database entry is updated.

g. Threshold filtering: at the end of this step, each word or token in a set is assigned a score, which may be used for matching calculation. The value of the threshold may be adjusted to have at least 20 words in 80% of the bags.

At the end of this process, the result may be a set of scored error tokens 216 for each error message along with their TF-IDF scores. The result may be pre-cached and reside in memory in some embodiments.

As one of ordinary skill in the art with the benefit of this disclosure will understand, various other types of NLP may also be performed to arrive at this set of scored error tokens.

The troubleshooting system may also have a database of troubleshooting content 214 such as videos, whitepapers, user guides, customer support responses, etc. Similar or different NLP techniques may be applied at step 212 to items of troubleshooting content 214 to arrive at a set of scored troubleshooting tokens 218. For example, for videos, the video title and description may be used; for other types of content, the entire text may be used.

At step 220, a primary score (a similarity score) for an item of troubleshooting content with respect to a particular error may be determined by comparing the similarity of their respective vectors.

As discussed above, these vectors may be formed from bags of words/tokens and their respective relevance scores. In one embodiment, the primary score may be determined as follows.

a. Getting the score for a single document and a single MessageID. Cosine similarity scoring may be applied to the vectors of TF-IDF values to calculate the score according to the equation Score=V1.V2/(|V1∥V2|). Cosine similarity may be a relevant metric because the document size is almost similar, and most range bounded for size. Further, the troubleshooting words are typically within a well-defined library set.

b. For multiple MessageIDs. This may be calculated for a document as the sum of (score for each MessageID for the document) as in step a. This will give the score for each document for the case of multiple MessageIDs.

In other embodiments, alternate similarity measures may also be applied, such as Latent Dirichlet Allocation, etc.

The primary score may be used to generate a primary ranking, which is the order in which the troubleshooting system presents items of troubleshooting content (e.g., ordered from highest primary score to lowest primary score).

As further shown in method 200, the primary score may be continually or continuously adjusted based on user feedback by calculating a secondary score, as shown in the loop at steps 222, 224, 226, and 228.

The user may be prompted to provide feedback on the item(s) of troubleshooting content that the troubleshooting system has provided/recommended. In various embodiments, such feedback may take the form of numerical rankings (e.g., 1-10), binary rankings (e.g., “relevant” vs. “not relevant” or “helpful” vs. “unhelpful”), etc. In the discussion below, for the sake of concreteness and clarity, a binary ranking is used. Thus a feedback loop is provided to adjust the primary score/primary ranking with a modifier.

A weighted feedback system may be used in some embodiments. As one of ordinary skill in the art with the benefit of this disclosure will understand, various techniques may be used for quantitatively incorporating the feedback into the secondary ranking. In some embodiments, the secondary ranking may be calculated according to the formula:

Secondary Ranking=(100−(50−% users finding video helpful))*0.01

For example, 50% is a neutral number. If 70% of users are finding the content relevant, the rank of the content may be increased by 1.2*Primary Ranking. If 25% of users are finding the video helpful, the ranking will become 0.75*Primary Ranking. As one of ordinary skill in the art with the benefit of this disclosure will understand, various other scoring schemes may also be used.

This will ensure that the content being listed is incorporating user feedback and is affected with each feedback event.

The cumulative score may then be used to rank the document match score using both the primary score and the secondary feedback score mechanism. In some embodiments, a separate troubleshooting section may be provided with rankings for each type of troubleshooting content (e.g., ranked videos in a video section, ranked whitepapers in a whitepaper section, etc.).

The overall rank for an item of content may then be determined according to the equation:

Rank=Primary Ranking*Secondary Ranking

Users may then be provided with results based on the adjusted rank, and they may again be provided with the opportunity to provide feedback about one or more items of troubleshooting content, allowing the system to continually improve its recommendations.

In addition to changing the relative ranking for items of troubleshooting content, the user feedback may be used (additionally or alternatively) to adjust the relevance scores for each token in the error vectors and/or troubleshooting vectors. This technique may be seen as an interaction between steps 220, 216, and 218. For example, a particular item of content may initially be ranked highly for a given error based on a match between a given highly-ranked token in the corresponding vectors. If users provide feedback that the item is not relevant, however, then the respective vectors may be adjusted so that that token receives a reduced relevance score. For example, a particular item of troubleshooting content may simply not be very helpful in general. Its vector may, over time, come to reflect that by having reduced values for every token.

Thus embodiments of the present disclosure may provide many advantages over existing troubleshooting systems. For example, embodiments may handle the collective information for multiple error messages to get collective ranking of troubleshooting data. Specifically, the use of domain-specific combination words to provide heavy ranking for specific combinations may provide advantages. Further, the sets of token created may be based on guidance from a tagger along with self-learning, and may further be based on hardware components. As a result, the sets of keywords may themselves be relatively unique and specific to the domain. Still further, the usage of a primary score (which is based on static document matching) along with secondary score (which is based on dynamic recommendations) is particularly advantageous.

One of ordinary skill in the art with the benefit of this disclosure will understand that the preferred initialization point for the method depicted in FIG. 2 and the order of the steps comprising that method may depend on the implementation chosen. In these and other embodiments, this method may be implemented as hardware, firmware, software, applications, functions, libraries, or other instructions. Further, although FIG. 2 discloses a particular number of steps to be taken with respect to the disclosed method, the method may be executed with greater or fewer steps than depicted. The method may be implemented using any of the various components disclosed herein (such as the components of FIG. 1), and/or any other system operable to implement the method.

Although various possible advantages with respect to embodiments of this disclosure have been described, one of ordinary skill in the art with the benefit of this disclosure will understand that in any particular embodiment, not all of such advantages may be applicable. In any particular embodiment, some, all, or even none of the listed advantages may apply.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
one or more processors; and
a non-transitory memory coupled to the one or more processors;
wherein the information handling system is configured to:
receive, from a client information handling system, information indicative of an error;
perform natural language processing of a text associated with the error to determine a set of error tokens;
perform natural language processing of a plurality of items of troubleshooting content to determine, for each item of troubleshooting content, a respective set of troubleshooting tokens;
for each respective set of troubleshooting tokens, determine a similarity score for the corresponding item of troubleshooting content relative to the set of error tokens;
receive user feedback for a selected one of the items of troubleshooting content; and
adjust the similarity score for the selected one based on the received user feedback.

2. The information handling system of claim 1, wherein the information indicative of the error further includes a model number and/or a service tag of the client information handling system.

3. The information handling system of claim 2, wherein the information handling system is further configured to filter the items of troubleshooting content to remove those items that are not associated with the model number and/or service tag.

4. The information handling system of claim 1, wherein the information indicative of the error includes an error code.

5. The information handling system of claim 1, wherein the text associated with the error includes remediation instructions.

6. The information handling system of claim 1, wherein the error tokens and the troubleshooting tokens comprise single words.

7. The information handling system of claim 1, wherein the error tokens and the troubleshooting tokens comprise groupings of words.

8. A method comprising:
an information handling system receiving, from a client information handling system, information indicative of an error;
the information handling system performing natural language processing of a text associated with the error to determine a set of error tokens;
the information handling system performing natural language processing of a plurality of items of troubleshooting content to determine, for each item of troubleshooting content, a respective set of troubleshooting tokens;
for each respective set of troubleshooting tokens, the information handling system determining a similarity score for the corresponding item of troubleshooting content relative to the set of error tokens;
the information handling system receiving user feedback for a selected one of the items of troubleshooting content; and
the information handling system adjusting the similarity score for the selected one based on the received user feedback.

9. The method of claim 8, further comprising transmitting the selected one of the items of troubleshooting content to the user.

10. The method of claim 8, further comprising retrieving the text associated with the error from an error database.

11. The method of claim 8, wherein performing natural language processing of the text includes calculating term frequency-inverse document frequency (TF-IDF) processing on the text.

12. The method of claim 8, wherein the error tokens each have a respective error relevance score, and wherein each troubleshooting token for each item of troubleshooting content has a respective troubleshooting relevance score.

13. The method of claim 12, further comprising:
computing an error vector associated with the text, the error vector comprising the respective error relevance score for each error token;
computing troubleshooting vectors associated with each item of troubleshooting content, each troubleshooting vector comprising the respective troubleshooting relevance scores for each associated troubleshooting token.

14. The method of claim 13, wherein the similarity score is determined based on a cosine similarity between the error vector and each respective troubleshooting vector.

15. An article of manufacture comprising a non-transitory, computer-readable medium having computer-executable code thereon that is executable by at least one processor of at least one information handling system for:
receiving, from a client information handling system, information indicative of an error;
performing natural language processing of a text associated with the error to determine a set of error tokens;
performing natural language processing of a plurality of items of troubleshooting content to determine, for each item of troubleshooting content, a respective set of troubleshooting tokens;
for each respective set of troubleshooting tokens, determining a similarity score for the corresponding item of troubleshooting content relative to the set of error tokens;
receiving user feedback for a selected one of the items of troubleshooting content; and
adjusting the similarity score for the selected one based on the received user feedback.

16. The article of claim 15, wherein the error tokens include domain-specific groupings of words.

17. The article of claim 15, wherein the information indicative of the error further includes a model number and/or a service tag of the client information handling system, and wherein the code is further executable for filtering the items of troubleshooting content to remove those items that are not associated with the model number and/or service tag.

18. The article of claim 15, wherein the error tokens each have a respective error relevance score, and wherein each troubleshooting token for each item of troubleshooting content has a respective troubleshooting relevance score.

19. The article of claim 18, wherein the code is further executable for:
computing an error vector associated with the text, the error vector comprising the respective error relevance score for each error token;
computing troubleshooting vectors associated with each item of troubleshooting content, each troubleshooting vector comprising the respective troubleshooting relevance scores for each associated troubleshooting token.

20. The article of claim 19, wherein the similarity score is determined based on a cosine similarity between the error vector and each respective troubleshooting vector.
